(19) United States
(12) Patent Application Publication
(10) Pub. No.: US 2005/0015285 A1
(43) Pub. Date: Jan. 20, 2005

(54) Method and system for intelligent delivery of contents in a network

(75) Inventor: Tsuyoshi Tamaki, Hachioji (JP)

Correspondence Address: REED SMITH LLP, 3110 FAIRVIEW PARK DRIVE, SUITE 1400, FALLS CHURCH, VA, 22042, US

(73) Assignee: Hitachi, Ltd.

(21) Appl. No.: 10/637,550

(22) Filed: Aug. 11, 2003

(30) Foreign Application Priority Data
Jul. 17, 2003 (JP) 2003-198187

(51) Int. Cl. G06F 17/60

(52) U.S. Cl. 705/5

(57) ABSTRACT

An invention for a system and method of delivering contents to a user terminal from a contents delivery server is provided. In one example, the method includes determining reservation information, determining accessibility to the contents delivery server, sending a delivery request to the contents delivery server according to the reservation information, and receiving contents from the contents delivery server.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

1. Field of the Invention

The present invention generally relates to contents delivery systems and, more particularly, to techniques for delivering contents based on information gathered from user reservation information, network loads at network access points, and behavior of user terminals in a contents delivery system.

2. Discussion of Background

Whether a company is an enterprise, a service provider, or an e-business, the success of the company will be determined in part by accessibility of its content and by its ability to manage its network. The network must deliver content with an exceptional quality of service. As content and network architecture become more complex, traditional solutions to content delivery will not meet these challenges.

Further, the importance of delivering targeted, relevant, and timely content to wireless devices is increasing dramatically. More users are accessing the Internet with mobile computing devices ranging from cellular phones to pocket personal computers (PCs) and other personal digital assistants.

FIG. 1A is a schematic diagram of a conventional system 100 for delivering content to a user terminal 116. The user terminal 116 may be a wireless device, such as a cellular phone. As an example, a cellular phone may include a miniature web browser for surfing the web. A user may utilize a uniform resource locator (URL) to point the miniature web browser to a web site that includes an interface for accessing the contents 104 of a company. This access request is implemented by the user terminal 116, which obtains access 118 to a cellular network 112. The cellular network 112 has access 118 to the Internet 102. The Internet 102 has access to the contents delivery server 106, which has access to the contents 104. The user terminal 116 may then receive a download 120 of the contents 104 through the indirect link established by the cellular network 112.

FIG. 1B shows a simplified schematic diagram of the conventional system 100 of FIG. 1A. The user terminal 116 obtains access 118 to the contents 104 via the cellular network 112 and the contents delivery server 106. The user terminal 116 immediately receives a download 120 of the contents 104.

It is important to note that in the conventional system 100, the download 120 is typically received immediately after access 118 is obtained. Unfortunately, immediately receiving a download 120 has disadvantages. The connection to the contents 104 may not have adequate bandwidth for a fast download. In FIG. 1A, for example, the user terminal 116 may have poor radio frequency (RF) reception to the cellular network 112. In such a case, the user may desire to switch to a different network type altogether (e.g., a wireless local area network (LAN)).

However, conventional user terminals 116 are not designed to switch easily to a different network type for purposes of receiving a faster download. The user has the option of manually logging on to the contents delivery server 106 via a different network type (e.g., a wireless LAN) in the hopes of receiving a faster connection. As an alternative, the user may wait until another time when the cellular network 112 might not be so busy. These options for a user to obtain a faster download 120 leave a lot to be desired. Many users will simply give up on trying to download the contents 104.

In sum, the importance of delivering content to user terminals is rapidly increasing. However, conventional content delivery systems do not provide a practical method for user terminals, particularly wireless devices, to receive downloads.

### SUMMARY OF THE INVENTION

It has recognized that there is a need for delivering Internet content to user terminals, particularly wireless devices. There is also a need for features in an Internet content management system that will facilitate a successful wireless device implementation. Broadly speaking, the present invention fills these needs by providing a system and method of delivering contents to a user terminal from a contents delivery server. It should be appreciated that the present invention can be implemented in numerous ways, including as a process, an apparatus, a system, a device or a method. Several inventive embodiments of the present invention are described below.

In one embodiment, a method is provided for downloading contents from a contents deliver server. The method comprises determining reservation information, determining accessibility to the contents delivery server, sending a delivery request to the contents delivery server according to the reservation information, and receiving contents from the contents delivery server.

In another embodiment, a method is provided for delivering contents to a terminal. The method comprises receiving reservation information from the terminal, confirming accessibility to the terminal, and sending a contents delivery request to a contents delivery server according to the reservation information.

As content providers increasingly make content available to user terminals, such as wireless devices, the content providers must become more intelligent in their abilities to deliver content. Advantageously, the present invention helps content providers scale their current infrastructures without having to overhaul their networks. The present invention allows content providers to leverage their existing networks in order to make the networks more powerful and smarter.

The invention encompasses other embodiments of a method, a system, an apparatus, and a computer-readable medium, which are configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1A is a schematic diagram of a conventional system for delivering content to a user terminal;

FIG. 1B shows a simplified schematic diagram of the conventional system of FIG. 1A;

FIG. 2 shows a system for delivering content to a user terminal, in accordance with an embodiment of the present invention;

FIG. 3A is a schematic diagram of a network control method for delivering content, in accordance with an embodiment of the present invention;

FIG. 3B is a schematic diagram of a terminal access method for delivering content, in accordance with an embodiment of the present invention;

FIG. 4 shows graphs that illustrate techniques for making a delivery timing judgment for downloading the content, in accordance with an embodiment of the present invention;

FIG. 5 shows a user terminal display for collecting reservation information from a user, in accordance with an embodiment of the present invention;

FIG. 6 shows a system for delivering content to a user terminal using the network control method of FIG. 3A, in accordance with an embodiment of the present invention;

FIG. 7 shows a system for delivering content to a user terminal using the terminal access method of FIG. 3B, in accordance with an embodiment of the present invention;

FIG. 8 is a schematic diagram of a method for user log information collection into the user log database, in accordance with an embodiment of the present invention;

FIG. 9 is a detailed view of data collected into the user log database, in accordance with an embodiment of the present invention;

FIG. 10 is a schematic diagram of a method for network load information collection into the network load database, in accordance with an embodiment of the present invention;

FIG. 11 is a detailed view of data collected into the network load database, in accordance with an embodiment of the present invention;

FIG. 12 is a more detailed schematic diagram of the network control method of FIG. 3A, in accordance with an embodiment of the present invention; and

FIG. 13 is a more detailed schematic diagram of the terminal access method of FIG. 3B, in accordance with an embodiment of the present invention.

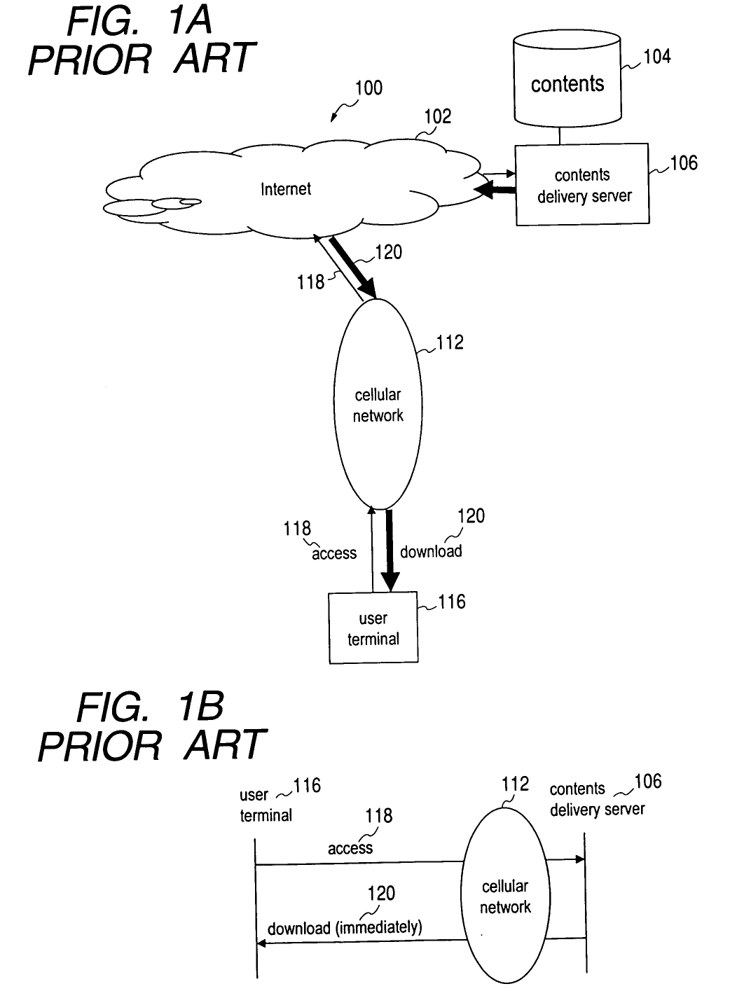

### DESCRIPTION OF THE PREFERRED EMBODIMENTS

An invention for a system and method of delivering contents to a user terminal from a contents delivery server is disclosed. Numerous specific details are set forth in order to provide a thorough understanding of the present invention. It will be understood, however, to one skilled in the art, that the present invention may be practiced without some or without all of these specific details. The term “device” as used in the present invention means hardware, software, or combination thereof. The term “delivery” may be used interchangeably in the present invention with the term “download”, and vice versa. The term “delivering” may be used interchangeably in the present invention with the term “downloading”, and vice versa.

General Overview Of System And Method

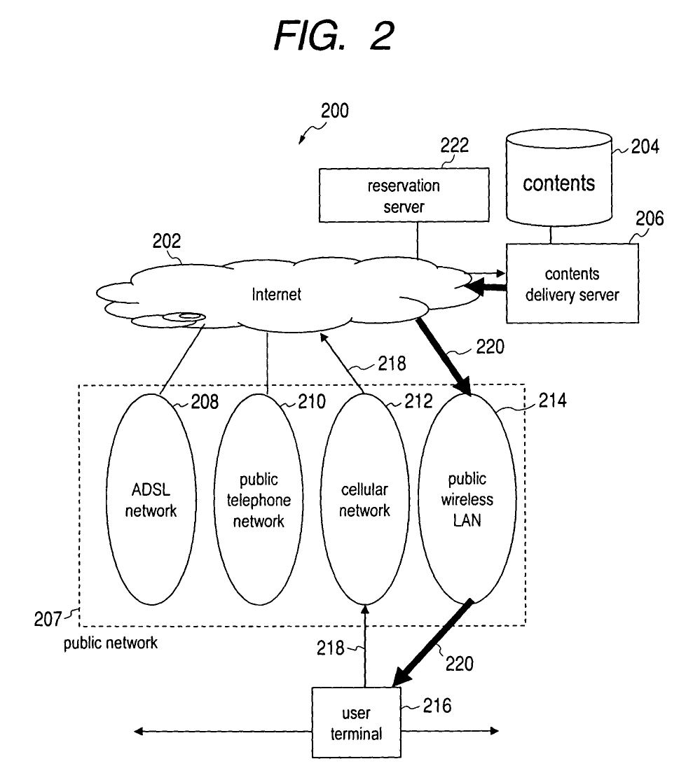

FIG. 2 shows a system 200 for delivering content to a user terminal 216, in accordance with an embodiment of the present invention. The user terminal 216 may be a wireless device, such as a cellular phone. As an example, a cellular phone may include a miniature web browser for surfing the web. A user may utilize a uniform resource locator (URL) to point the miniature web browser to a web site that includes an interface for accessing the contents 204 of a company. This access request is implemented by the user terminal 216, which obtains access 218 to a cellular network 212. The cellular network 212 has access 218 to the Internet 202. The Internet 202 has access to the contents delivery server 206 and the reservation server 222. The contents deliver server 206 has access to the contents 204.

The user terminal 216 sends reservation information 500 to a reservation server 222 in order to set appropriate timing for the download 220. The reservation server 222 is configured to receive reservation information 500 from other user terminals as well. Based on calculated user access timing and content delivery timing, the reservation server 222 determines an appropriate time for the download 220 to the user terminal 216. This technique allows delivery of mass contents automatically and cheaply.

It is important to note that the user does not necessarily know the appropriate time of the download 220. In other words, the download happens at some appropriate time and may happen without the user being aware the download is occurring. Accordingly, the download 220 may be a push download, meaning, a download performed without a request for the download from the user terminal 216.

In order to complete the download, the system 200 may utilize a network type that is available to the system 200. For explanatory purposes, FIG. 2 illustrates an available network as being a public network 207, including a public wireless local area network (LAN) 214, a cellular network 212, an asymmetric digital subscriber line (ADSL) network 208, and a public telephone network 210. However, the present invention is not limited to public networks, nor to the specific network types illustrated in FIG. 2. Alternatively, the system 200 may use private networks, as well as other specific network types, such as wired LAN's, wired wide area networks (WAN's), wireless WAN's, symmetric digital subscriber line (SDSL) networks, cable networks, fiber optics networks, etc.

Further, the user terminal 216 may be of another device type, such as a pocket PC, a laptop computer with a wireless modem, a personal digital assistance, a desktop computer, etc. The network combination, for access and for download, depends on the type of user terminal 216 used. For explanatory purposes, the present invention uses a cellular network 212 while explaining reservation 218, and uses a public wireless LAN 214 while explaining download 220.

In the example of FIG. 2, the reservation server 222 instructs the contents delivery server 206 to deliver the contents through the public wireless LAN 214. Accordingly, the user terminal 216 accesses the contents 204 via the cellular network 212, but receives a download 220 via the public wireless LAN network 214.

Note that FIG. 2 shows the reservation server 222 and the contents delivery server 206 as being two separate devices. However, the present invention is not so limited. Alternatively, the reservation server 222 and the contents delivery server 206 may be comprised in a single server device.

More Details Of System And Method

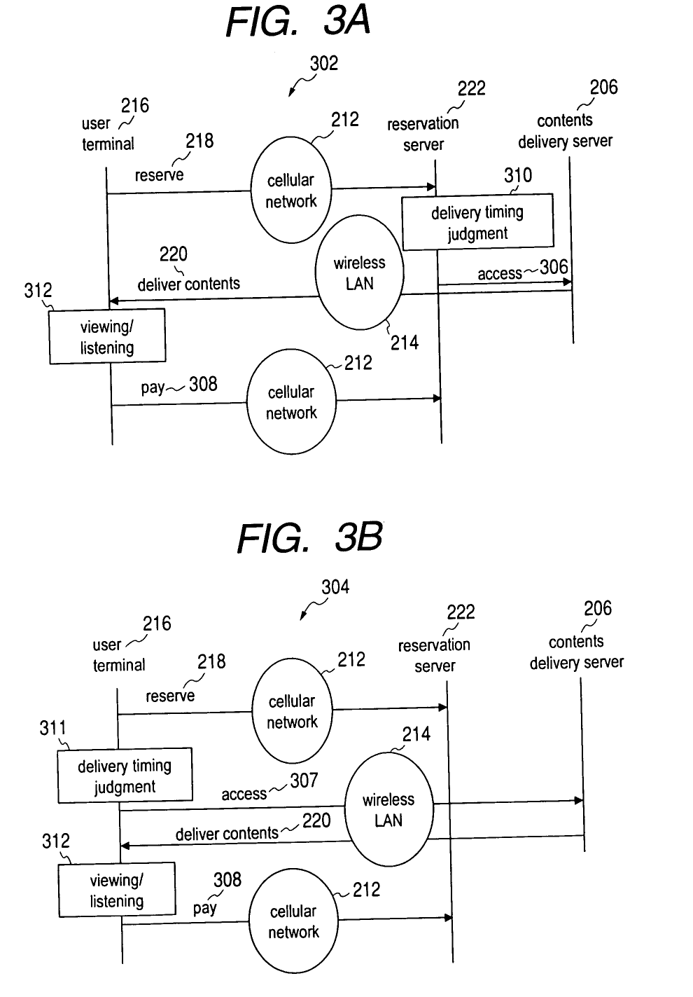

FIG. 3A is a schematic diagram of a network control method 302 for delivering content, in accordance with an embodiment of the present invention. A user inputs reservation information 500 into the user terminal 216. The user terminal reserves 218 the requested timing by sending the reservation information 500 to the reservation server 222 via the cellular network 212.

The reservation server 222 is configured to receive reservation information 500 from other user terminals as well. The reservation server 222 calculates user access timings and content delivery timings for one or more user terminals. The reservation server 222 is thereby configured to make a delivery timing judgment 310 to determine an appropriate time for the download 220 to the user terminal 216. The reservation server 222 is also configured to determine an optimal network for completing the download 220. In the example of FIG. 3A, the reservation server 222 determines the wireless LAN 214 to be the optimal network.

The reservation server 222 then accesses 306 the contents delivery server 206 at the appropriate time, and instructs the contents deliver server 206 to perform a contents deliver. The contents deliver server 206 responds by performing a contents delivery 220 via the wireless LAN 214 to the user terminal 216. The user may then view or listen 312 to the contents 204. The user terminal 216 is configured to perform a payment procedure 308 with the reservation server 222 via the cellular network 212 after contents delivery.

FIG. 3B is a schematic diagram of a terminal access method 304 for delivering content, in accordance with an embodiment of the present invention. A user inputs reservation information 500 into the user terminal 216. The user terminal reserves 218 the requested timing by sending the reservation information 500 to the reservation server 222 via the cellular network 212.

The reservation server 222 is configured to receive reservation information 500 from other user terminals as well. In the case of FIG. 3B, the user terminal 216 calculates user access timings and content delivery timings. The user terminal 216 is configured to make a delivery timing judgment 311 to determine an appropriate time for the download 220 to the user terminal 216. The user terminal 216 may also be configured to determine an optimal network for completing the download 220. In this example, the user terminal 216 determines the wireless LAN 214 to be the optimal network.

The user terminal 216 then accesses 307 the contents delivery server 206 via the wireless LAN 214 at the appropriate time. The contents delivery server 206 downloads contents 220 via the wireless LAN 214, as determined by the user terminal 216. The user may then view or listen 312 to the contents 204. The user terminal 216 is configured to perform a payment procedure 308 with the reservation server 222 via the cellular network 212.

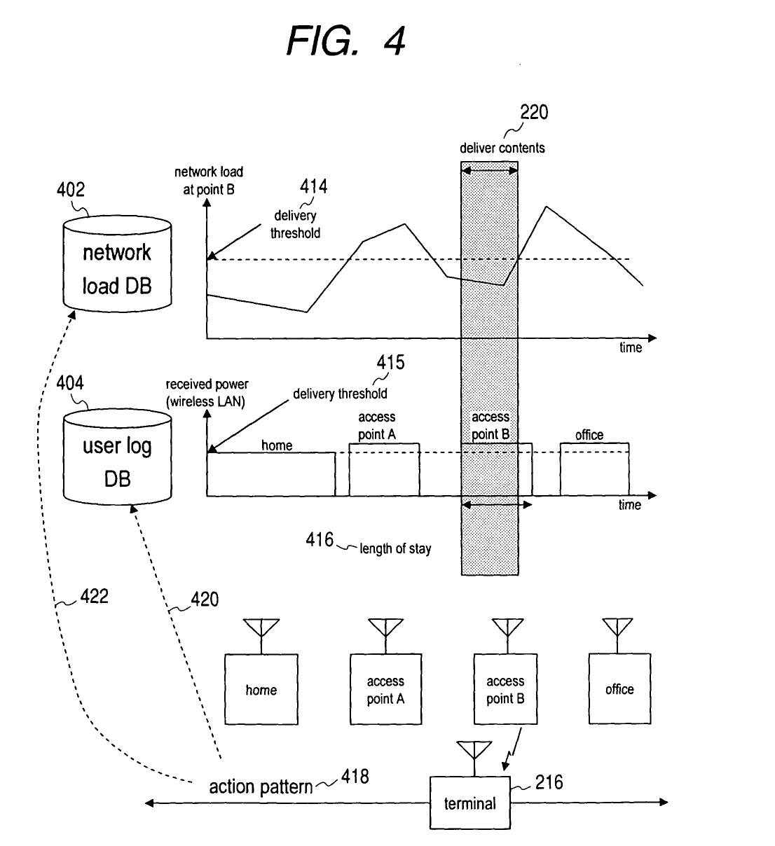

FIG. 4 shows graphs that illustrate techniques for making a delivery timing judgment 310 for downloading the content, in accordance with an embodiment of the present invention. Note that in many cases, content does not need to be delivered immediately. In such cases, advantageously, contents delivery may be performed at a time when the contents delivery would not overload the network.

A delivery timing judgment 310 is made using the network control method 302 or the terminal access method 304. The example of FIG. 4 shows statistics gathered for a wireless LAN 214 at various access points. Access points are locations at which the user terminal can access the wireless LAN 214. For explanatory purposes, the access points include home, access point A, access point B, and office. The action pattern 418 of FIG. 4 shows the user terminal 216 as moving between home, access point A, access point B, and office. As the user moves the user terminal 216 between the various access points, statistics are gathered.

The network load database 402 includes a collection of statistics on the behavior of networks of the system 200. The network load database 402 keeps track of network loads at each access point in the network, with respect to time. Based on the locations of the user terminals in the given network, network load information collection 422 is performed. As shown in FIG. 4, the network load database 402 stores statistics on the network load of the wireless LAN 214 at access point B.

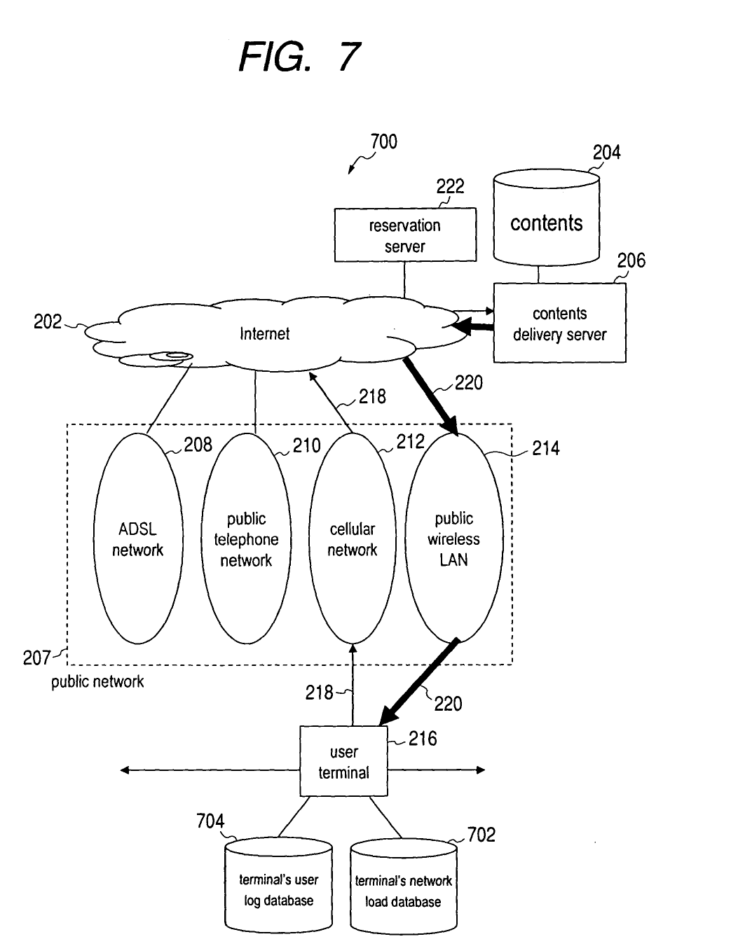

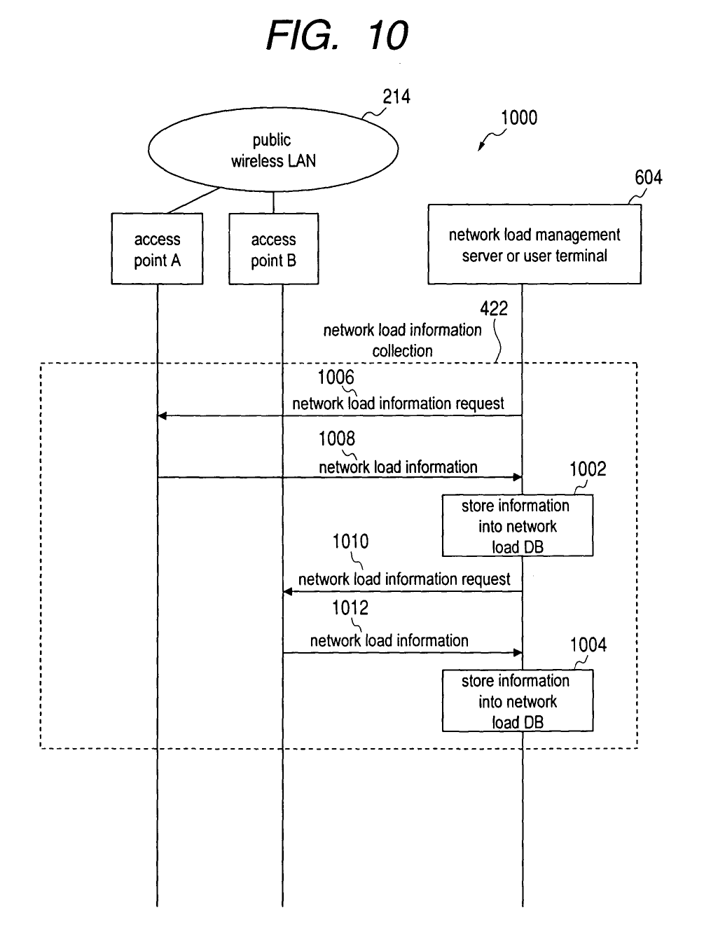

Note that the terminal's network load database 702, which is discussed below with reference to FIG. 7 and FIG. 10, is used to collect network load information in a similar manner the network load database 402 is used to collect network load information. However, the terminal's network load database 702 is configured to store primarily the network load information that is relevant to a particular user terminal 216. For example, the terminal's network load database 702 is not configured to store information about an access point that is routinely never accessed by the particular user terminal 216. Storing such extraneous information would unduly fill up the terminal's network load database 702. On the other hand, the network load database 402 may include information pertaining to all the access points that are accessed by the user terminals in the network. In short, the use of the terminal's network load database 702 is similar to the use of the network load database 402, except tailored for the particular user terminal 216.

The user log database 404 includes a collection of statistics on behaviors of users of the system 200. The user log database 404 keeps track of received power of each user terminal 216 at each access point in the network, with respect to time. Based on the locations of each user terminal 216 in the given network, user log information collection 420 is performed. As shown FIG. 4, the user log database 404 stores statistics on the behavior of a particular user terminal 216 in the wireless LAN 214 at access point B. The user log database 404 assists in the making of the delivery timing judgment 310. Specifically, the user log database 404 provides information for making a determination of when the user terminal 216 is likely to be accessible for contents delivery 220.

Note that the terminal's user log database 704, which is discussed below with reference to FIG. 7 and FIG. 8 and FIG. 13, is used to collect user log information in a similar manner the user log database 404 is used to collect user log information. However, the terminal's user log database 704 is configured to store primarily the user log information that is relevant to a particular user terminal 216. For example, the terminal's user log database 704 is not configured to store information about accessibility histories of other user terminals besides the particular user terminal 216. Storing such extraneous information would unduly fill up the terminal's user log database 704. On the other hand, the user log database 404 may include information pertaining to accessibility histories of all the user terminals in the network. In short, the use of the terminal's user log database 704 is similar to the use of the user log database 404, except tailored for the particular user terminal 216.

Different contents delivery methods make use of the databases in different ways. If the network control method 302 is used, the reservation server requires information from the network load database 402, as well as information from the user log database 404. The reservation server 222 establishes a delivery threshold 414 for the network load database. This delivery threshold 414 establishes a network load value below which content delivery is permissible for a given network and a given user terminal 216.

The reservation server 222 also sets a delivery threshold 415 for the user log database 404. This delivery threshold 415 establishes a received power value above which content delivery is permissible to a given user terminal 216. The shaded area of FIG. 4 shows a time period at which content delivery is permissible for the given network at access point B and permissible for the given user terminal at access point B. During this time period, the reservation server 222 may instruct the contents delivery server 206 to perform a contents delivery 220. Accordingly, the network load database 402 and the user log database assist in the making of the delivery timing judgment 310, including the making of a schedule of appropriate contents delivery timings that will not overload the network.

If the terminal access method 304 is used, the user terminal 216 requires information from the user log database 404. The user terminal 216 sets a delivery threshold 415 for the user log database 404. This delivery threshold 415 establishes a received power value above which content delivery is permissible to a given user terminal 216. For the terminal control method 304, the shaded area of FIG. 4 represents a time period at which content delivery is permissible for the given user terminal at access point B. During this time period, the user terminal 216 may instruct the contents delivery server 206 to perform a contents delivery 220.

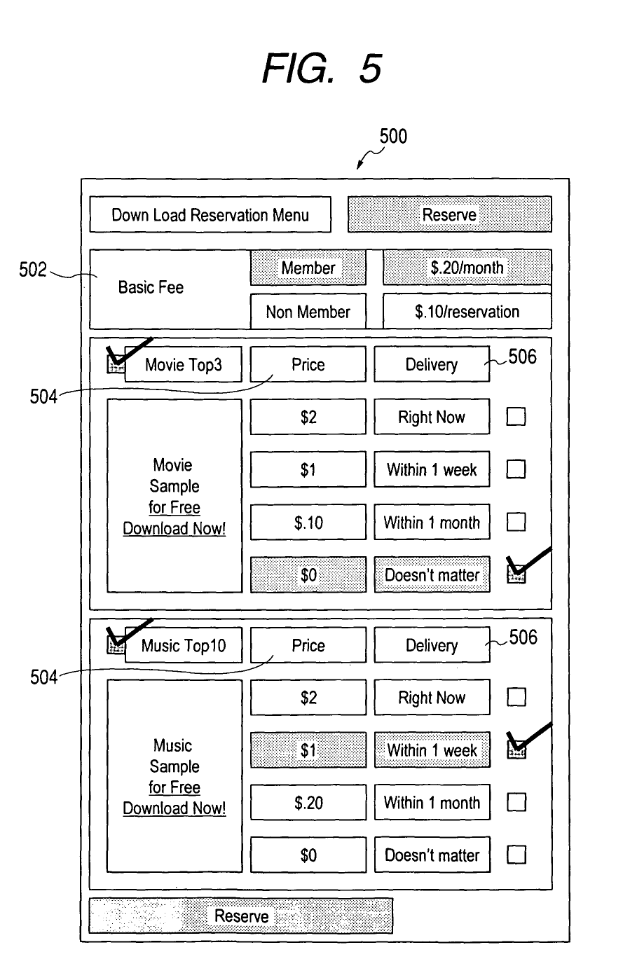

FIG. 5 shows a user terminal display for collecting reservation information 500 from a user, in accordance with an embodiment of the present invention. In the example of FIG. 5, the reservation information 500 is in a reservation form, which includes fields for selecting various options. The reservation form includes payment options 502, pricing options 504, and timing options 506. As shown in FIG. 5, a user has selected particular options. This particular user has opted to become a member at $0.20 per month. The user has reserved a download of Movie Top 3 at a time that doesn't matter to the user, which will cost the user $0. The user has also reserved a download of Music Top 10 to be downloaded within 1 week, which will cost the user $1. The longer the time limit for delivery selected with timing option 506, the more advantageous it is for determining delivery timing that does not overload the network. The user is therefore offered cheaper pricing for longer time limit.

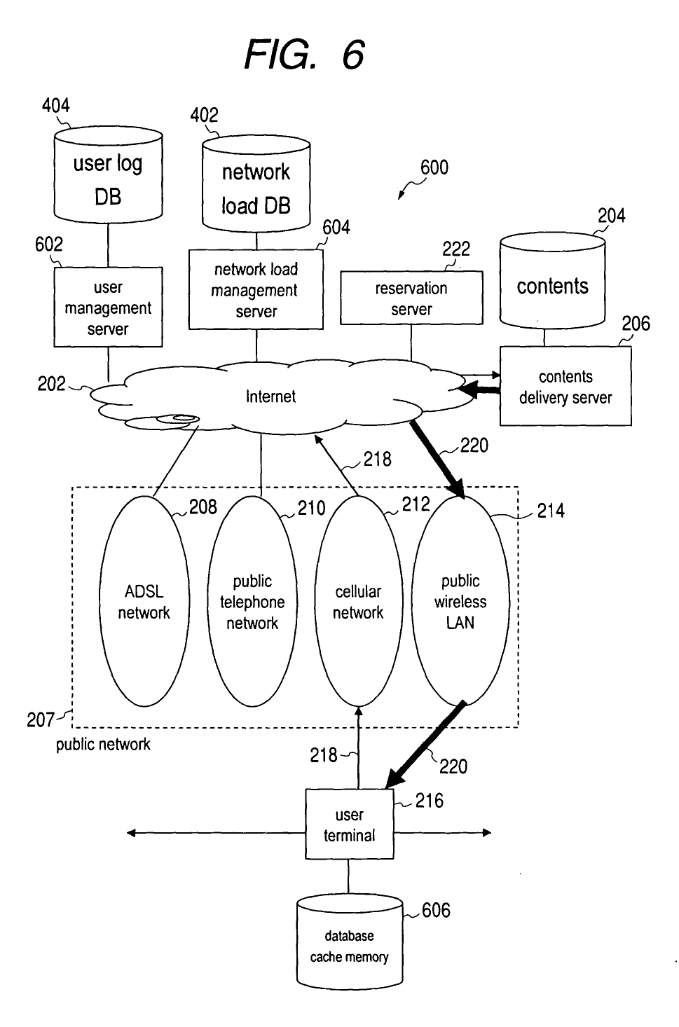

FIG. 6 shows a system 600 for delivering content to a user terminal 216 using the network control method 302 of FIG. 3A, in accordance with an embodiment of the present invention. The system 600 is similar to the system 200 of FIG. 2 with the addition of details related to the delivery timing judgment 310 using the network control method 302. The Internet 202 is connected to a user management server 602, which is connected to the user log database 404. The Internet 202 is connected to a network load management server 604, which is connected to the network load database 402. The user terminal 216 includes a database cache memory 606, which is configured to temporarily store certain contents of the user log database 404 and the network load database 402. Other features of the system 600 are substantially the same as the features of the system 200 of FIG. 2.

FIG. 7 shows a system 700 for delivering content to a user terminal 216 using the terminal access method 304 of FIG. 3B, in accordance with an embodiment of the present invention. The system 700 is similar to the system 200 of FIG. 2 with the addition of details related to the delivery timing judgment 310 using the terminal access method 304. The example of FIG. 7 shows that the user terminal 216 includes a terminal's user log database 704 and a terminal's network load database 702.

However, the embodiment is not so limited. Alternatively, the user terminal 216 may include no databases, or merely the terminal's user log database 704, or merely the terminal's network load database 702. Note that the terminal's databases are similar to, but not as substantial as, the user log data base 404 and the network load database 402. The terminal's databases include information that relates to the user terminal 216 specifically. Other features of the system 700 are substantially the same as the features of the system 200 of FIG. 2.

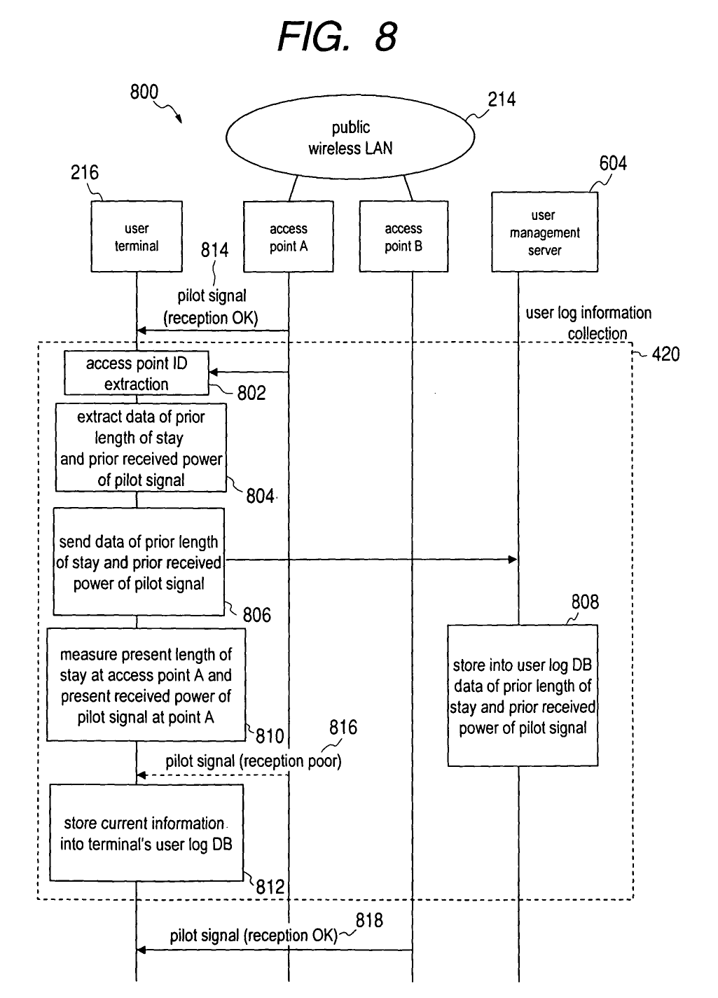

FIG. 8 is a schematic diagram of a method 800 for user log information collection 420 into the user log database 404, in accordance with an embodiment of the present invention. The user travels into a range in which the user terminal 216 has radio reception acceptable for connecting with access point A. The user terminal 216 receives a pilot signal 814 of radio reception that is acceptable. FIG. 8 shows the pilot signal 814 being received from access point A. However, the pilot signal 814 may be received from another access point, depending on where the user has traveled with the user terminal 216. While the pilot signal 814 is of acceptable reception, user log information collection 420 may continue to be performed.

In step 802, the user terminal 216 extracts an access point identification from access point A. The user terminal 216 then extracts prior data of length of stay and prior data of received power of pilot signal in step 804. This prior data includes information about the prior access point at which the user terminal 216 was before the present access point A. The prior access point could be any access point of the public wireless LAN 214. This prior data may be extracted from a database cache memory 606 or from the terminal's user log database 704. In step 806, the user terminal 216 sends this prior data to the user management server 604. The user management server 604 stores this prior data is into the user log database 404 in step 808.

In step 810, the user terminal 216 measures the present length of stay at access point A and the present received power of pilot signal at access point A. Note that step 810 may continuously be performed during the entire time the user terminal is in good reception with access point A. The user terminal 216 then receives a pilot signal 816 of poor reception. In step 812, the current information is stored into the database cache memory 606 or the terminal's user log database 704. The user log collection 420 is then done. The user may then travel with the user terminal 216 to another access point. The example of FIG. 8 shows that the user travels within the range of access point B. Accordingly, a pilot signal 818 of acceptable reception is received by the user terminal 216 from access point B.

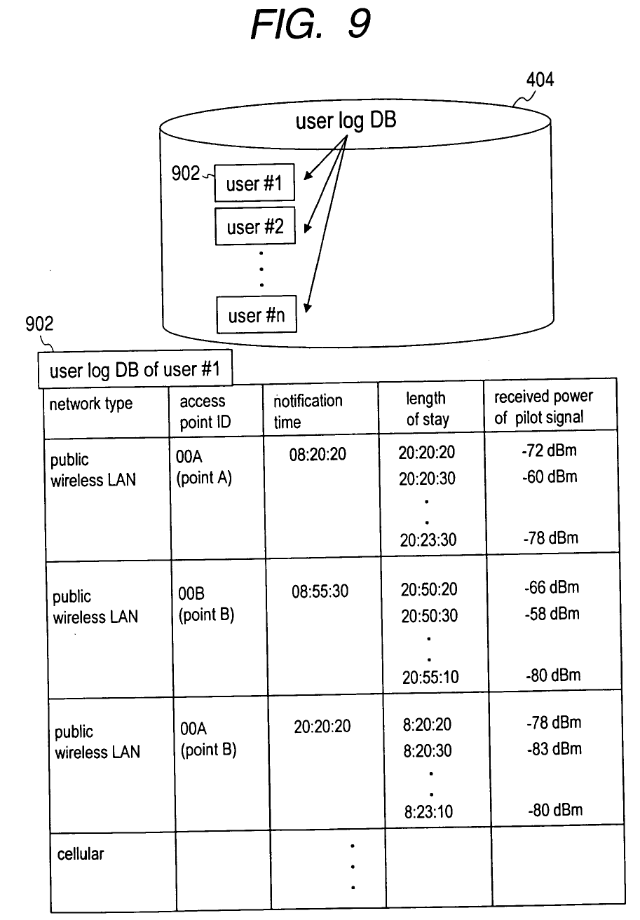

FIG. 9 is a detailed view of data collected into the user log database 404, in accordance with an embodiment of the present invention. The user log database 404 stores information on the accessibility histories of different user terminals, including user #1 to user #n, where n is an integer greater than 0. As an example, the user log database 902 of user #1 stores information, including network type, access point identification, notification time of when the user terminal 216 receives good reception at the given access point, length of stay at the given access point, and received power of the pilot signal from the access point to the user terminal 216. The unit “dBm” is a measurement of received power, 0 dBm equals 1 mW (e.g., 1 dBm=10*Log₁₀ (X mW), or X=10\hat{ }(0.1)=1.26 mW).

For explanatory purposes, FIG. 9 shows information gathered for the public wireless LAN 214 and for the cellular network 212. However, the present invention is not so limited. The user log database may store information for other networks available to the content delivery system.

FIG. 10 is a schematic diagram of a method 1000 for network load information collection 422 into the network load database 402 or terminal's network load database 702, in accordance with an embodiment of the present invention. For explanatory purposes, FIG. 10 shows network load information being gathered from access point A and from access point B. However, the present invention is not so limited. Network load information may be gathered from other access points available to the content delivery system.

The network load management server 604 or user terminal 216 sends a network load information request 1006 to access point A. Access point A responds by sending network load information 1008 to the network load management server 604 or user terminal 216. In step 1002, the network load management server 604 or user terminal 216 stores the network load information 1008 into the network load database 402 or terminal's network load database 702. The network load management server 604 or user terminal 216 then sends a network load information request 1010 to another access point, in this case, access point B. Access point B responds by sending network load information 1012 to the network load management server 604 or user terminal 216. In step 1004, the management server 604 or user terminal 216 stores the network load information 1012 into the network load database 402 or terminal's network load database 702.

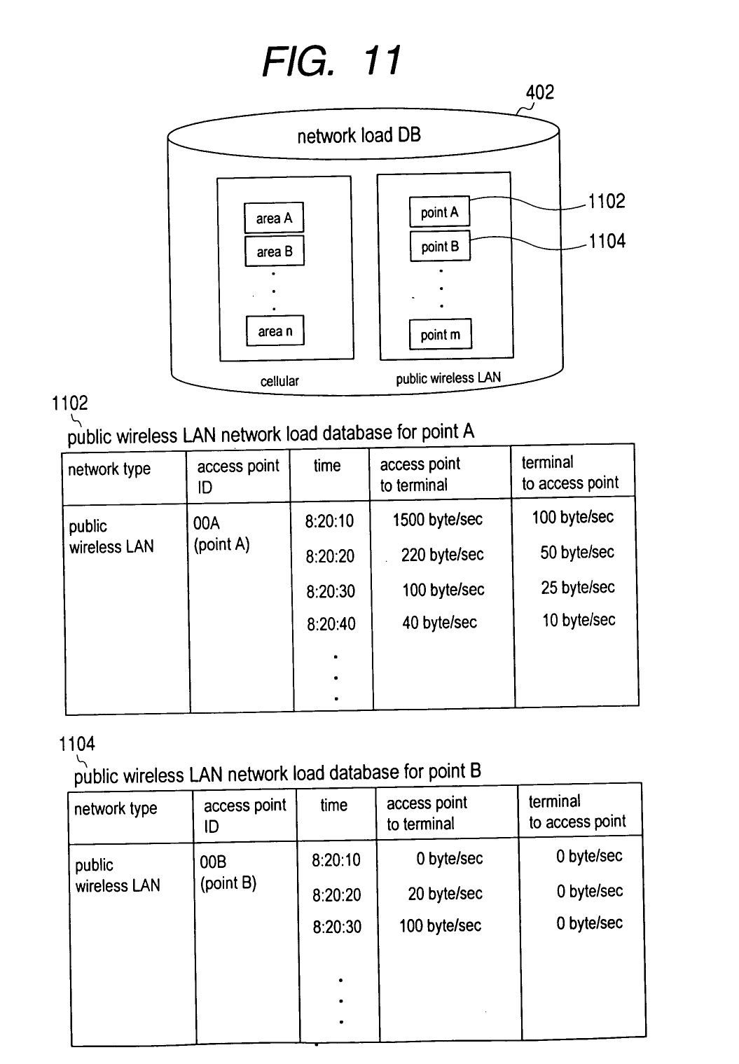

FIG. 11 is a detailed view of data collected into the network load database 402, in accordance with an embodiment of the present invention. The network load database 402 stores information on the network load at different locations in networks of the content delivery system. As an example, network load database 1102 is stored for access point A. The network load database 1102 stores information, including network type, access point identification, time of when the network load information 1008 was received, access point to terminal load at the given time, and terminal to access point load at the given time.

As another example of FIG. 11, network load database 1104 is stored for access point B. The network load database 1102 stores information, including network type, access point identification, time of when the network load information 1012 was received, access point to terminal load at the given time, and terminal to access point load at the given time.

For explanatory purposes, FIG. 11 shows cellular network information, including area A data through area n data, where n is some reference symbol other than A. FIG. 11 also shows public wireless LAN information, including access point A data 1102 through access point m data, where m is some reference symbol other than A. However, the present invention is not so limited. The network load database 402 may store information on other networks available to the content delivery system.

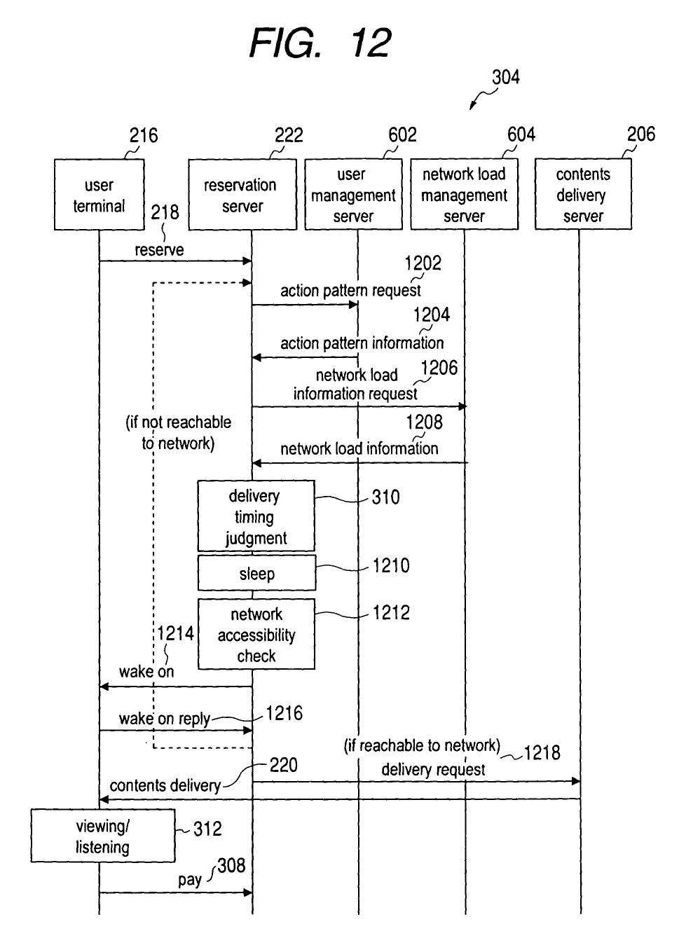

FIG. 12 is a more detailed schematic diagram of the network control method 302 of FIG. 3A, in accordance with an embodiment of the present invention. A user inputs reservation information 500 into the user terminal 216. The user terminal reserves 218 the requested timing by sending the reservation information 500 to the reservation server 222 via the cellular network 212.

The reservation server 222 sends an action pattern request 1202 to the user management server 602. The action pattern 418 is discussed above with reference to FIG. 4. The user management server 602 replies by sending action pattern information to the reservation server 222. This action pattern information includes statistics collected in the user log database 404. The reservation server 222 also sends a network load information request 1206 to the network load management server 604. The network load management server 604 responds by sending network load information 1208 to the reservation server 1208. This network load information 1208 includes statistics collected in the network load database 402.

The reservation server 222 is then configured to perform a delivery timing judgment 310. The delivery timing judgment is discussed above with reference to FIG. 3A. The delivery timing judgment sets the appropriate time at which the contents delivery server 206 is to perform the content delivery. If no activity takes place that requires at least normal power consumption, the reservation server 222 sleeps in step 1210. When the appropriate time arrives, the reservation server 222 performs a network accessibility check 1212 to verify that the selected network is available to the user terminal 216. For explanatory purposes, the selected network to perform the content delivery is the public wireless LAN 214.

The reservation server 222 sends a wake on request 1214 to the user terminal 216. Note that this wake on request 1214 is a wireless LAN wake on request in a wireless LAN, which is different than a wake on request of a different network type, such as a cellular network. If the user terminal 216 receives the wake on request 1214, the user terminal 216 responds by sending a wake on reply 1216 to the reservation server 222. If the user terminal 216 is not reachable to the wireless LAN 214, the method returns to the reservation server 222 requesting information from the user management server 602 and the network management server 604.

However, if the user terminal 216 is reachable to the wireless LAN 214, the reservation server 222 sends a delivery request 1218 to the contents delivery server 206. The contents deliver server 206 responds with a contents delivery 220 to the user terminal 216. In step 312, the user may then view or listen to the contents 204. The user terminal 216 is configured to send a payment 308 to the reservation server 222 via the cellular network 212.

Note that FIG. 12 shows the reservation server 222, the user management server 602, the network load management server, and the contents delivery server 206 to be separate devices. However, the embodiment is not so limited. Alternatively, any combination of the reservation server 222, the user management server 602, the network load management server, and the contents delivery server 206 may be comprised in a single server device.

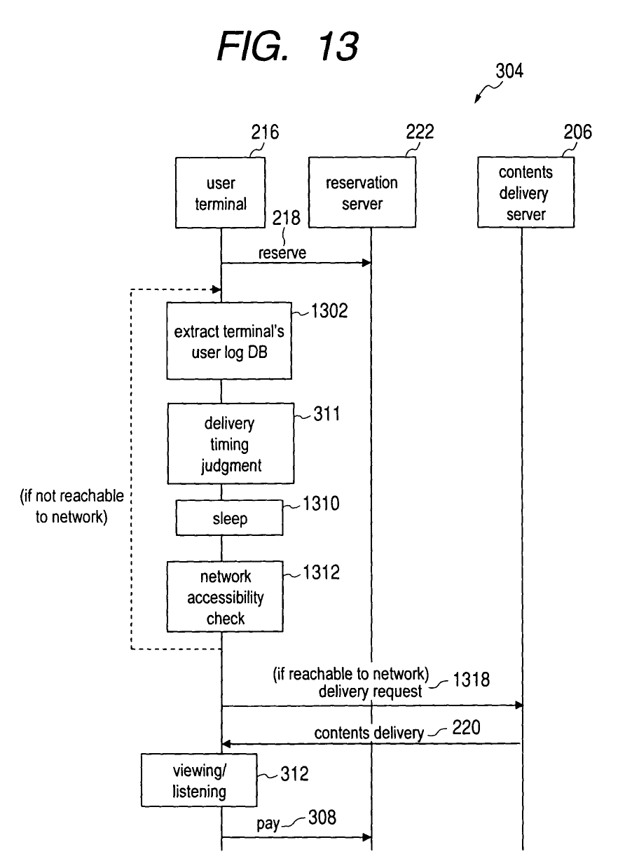

FIG. 13 is a more detailed schematic diagram of the terminal access method 304 of FIG. 3B, in accordance with an embodiment of the present invention. A user inputs reservation information 500 into the user terminal 216. The user terminal reserves 218 the requested timing by sending the reservation information 500 to the reservation server 222 via the cellular network 212. In step 1302, the user terminal 216 then extracts prior data of length of stay and prior data of received power of pilot signal. The user terminal 216 is configured to make a delivery timing judgment 311 to determine an appropriate time for the download 220 to the user terminal 216. If no activity takes place that requires at least normal power consumption, the user terminal 216 sleeps in step 1310.

When the appropriate time arrives, the user terminal 216 performs a network accessibility check 1312 to verify that the selected network is available to the user terminal. For explanatory purposes, the selected network to perform the content delivery is the public wireless LAN 214. If the user terminal 216 is not reachable to the wireless LAN 214, the method returns to the user terminal 216 extracting the terminal's user log database 702 in step 1302.

However, if the user terminal 216 is reachable to the wireless LAN 214, the user terminal 216 sends a delivery request 1318 to the contents delivery server 206. The contents delivery server 206 responds with a contents delivery 220 to the user terminal 216. In step 312, the user may then view or listen to the contents 204. The user terminal 216 is configured to send a payment 308 to the reservation server 222 via the cellular network 212.

System And Method Implementation

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including, but not limited to, determining reservation information, determining accessibility to the contents delivery server, sending a delivery request to the contents delivery server according to the reservation information, and receiving contents from the contents delivery server, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method for downloading contents from a contents deliver server, the method comprising:
determining reservation information;
determining accessibility to the contents delivery server;
sending a delivery request to the contents delivery server according to the reservation information; and
receiving contents from the contents delivery server.

2. The method of claim 1, wherein the step of determining reservation information is followed at least by:
sending the reservation information to a reservation server;
extracting user log information; and
determining an appropriate time for the contents delivery server to download the contents to a terminal based on the user log information.

3. The method of claim 2, wherein the step of extracting user log information includes extracting the user log information from a memory of the terminal, wherein the user log information is related to an action pattern of the user terminal.

4. The method of claim 1, wherein the step of determining reservation information includes receiving user selections from a reservation form, wherein the reservation form includes at least one of:
payment options;
pricing options; and
timing options.

5. The method of claim 2, wherein the step of sending the delivery request includes sending the delivery request by arrival of the appropriate time.

6. The method of claim 2, wherein the step of sending the reservation information includes sending the reservation information over a first network, wherein the step of sending the delivery request includes sending the delivery request over a second network, wherein the step of receiving the contents includes receiving the contents over the second network.

7. The method of claim 6, wherein the first network is a cellular network, wherein the second network is a wireless local area network.

8. The method of claim 1, wherein the step of determining accessibility includes performing a wireless local area network accessibility check.

9. The method of claim 1, further comprising sending a payment for the contents to the reservation server.

10. The method of claim 1, wherein a single server device is configured to comprise the reservation server and the contents delivery server.

11. The method of claim 1, wherein the steps of the method are stored on a computer-readable medium as one or more instructions, wherein the one or more instructions, when executed by one or more processors, cause the one or more processors to perform the steps of the method.

12. A method for delivering contents to a terminal, the method comprising:
receiving reservation information from the terminal;
confirming accessibility to the terminal; and
sending a contents delivery request to a contents delivery server according to the reservation information.

13. The method of claim 12, wherein the reservation information includes at least one of:
a payment option selection;
a pricing option selection; and
a timing option selection.

14. The method of claim 12, further comprising:
sending an action pattern information request to a user management server to obtain action pattern information of at least the terminal; and
receiving the action pattern information from the user management server.

15. The method of claim 14, further comprising:
sending a network load information request to a network load management server to obtain network load information of one or more access points; and
receiving the network load information from the network load management server.

16. The method of claim 15, further comprising determining an appropriate time for the contents delivery server to deliver the contents to the terminal based on at least the user log information or the network load information.

17. The method of claim 12, wherein the step of receiving reservation information includes receiving the reservation information over a first network, wherein the contents deliver request includes a request for the contents delivery server to send the contents over a second network.

18. The method of claim 17, wherein the first network is a cellular network, wherein the second network is a wireless local area network.

19. The method of claim 18, further comprising:
sending a wireless wake on request to the terminal; and
receiving a wireless wake on reply from the terminal.

20. The method of claim 15, wherein a reservation server is configured to perform the steps of the method, wherein a single server device is configured to comprise any combination of the reservation server, the user management server, the network load management server and the contents delivery server.
